(19) United States
(12) Patent Application Publication
(10) Pub. No.: US 2007/0234327 A1
(43) Pub. Date: Oct. 4, 2007

(54) Configuring media applications based on performance characteristics

(76) Inventors: Robert A. Baxter, Bedford, MA (US); Siddharth Mathur, Chestnut Hill, MA (US); David Michael Most, Somerville, MA (US); Rasekh Rifaat, Brookline, MA (US)

Correspondence Address: FISH & RICHARDSON PC, P.O. BOX 1022, MINNEAPOLIS, MN, 55440-1022, US

(21) Appl. No.: 11/479,034

(22) Filed: Jun. 30, 2006

Related U.S. Application Data
(63) Continuation-in-part of application No. 11/394,671, filed on Mar. 31, 2006.

(51) Int. Cl. G06F 9/45

(52) U.S. Cl. 717/151

(57) ABSTRACT

A method for configuring an application comprises receiving information that specifies a set of multiple states with which the application is associated during execution; receiving information that specifies whether each of one or more program modules is active during respective states, at least some of the program modules having multiple instantiations configured to execute with different performance characteristics; receiving information that specifies performance characteristics associated with the multiple instantiations for each of at least some program modules that have multiple instantiations; and selecting one of the instantiations for each program module that has multiple instantiations based on at least one performance criterion associated with the application that depends on whether the program modules are active in respective states.

### CROSS-REFERENCE TO RELATED APPLICATIONS

This application is a continuation-in-part application of and claims priority to U.S. application Ser. No. 11/394,671, filed on Mar. 31, 2006, incorporated herein by reference.

### TECHNICAL FIELD

The invention relates to configuring media applications based on performance characteristics.

### BACKGROUND

Communication systems for delivering content (e.g., multimedia content) from a server to a client include software that runs on the server and software that runs on a client device. Software modules on the client and server implement a communication protocol used over a network connection between the server and client. Classes of software applications that run on the client device include media browser applications and media player applications, for example. Media browser applications permit a user to search a catalog of content (e.g., audio or video content) on the server, select content of interest, and invoke a media player application to present the selected content to the user using the device display screen and/or speaker or headphones.

Some media browser applications for wireless mobile devices use the Wireless Access Protocol (WAP). Such browsers are called WAP browsers. Other mobile applications include Macromedia's Flash for mobile phones (Flash Lite), Synchronous Multimedia Integration Language (SMIL) players, and special purpose media search and playback applications.

In some approaches to delivering multimedia content data to a mobile device, the size of downloaded files, or the length of a data stream, is reduced by compressing the content data (or an approximate representation of the content data) using an encoder. The data is decompressed using a decoder that resides on the mobile device, for example, either as an installed software application or embedded in an integrated circuit on the mobile device.

### SUMMARY

In one aspect, in general, the invention features a method for configuring an application. The method comprises receiving information that specifies a set of multiple states with which the application is associated during execution; receiving information that specifies whether each of one or more program modules is active during respective states, at least some of the program modules having multiple instantiations configured to execute with different performance characteristics; receiving information that specifies performance characteristics associated with the multiple instantiations for each of at least some program modules that have multiple instantiations; and selecting one of the instantiations for each program module that has multiple instantiations based on at least one performance criterion associated with the application that depends on whether the program modules are active in respective states.

In another aspect, in general, the invention features software stored on a computer-readable medium, for configuring an application. The software includes instructions for causing a computer system to: receive information that specifies a set of multiple states with which the application is associated during execution; receive information that specifies whether each of one or more program modules is active during respective states, at least some of the program modules having multiple instantiations configured to execute with different performance characteristics; receive information that specifies performance characteristics associated with the multiple instantiations for each of at least some program modules that have multiple instantiations; and select one of the instantiations for each program module that has multiple instantiations based on at least one performance criterion associated with the application that depends on whether the program modules are active in respective states.

In another aspect, in general, the invention features a system for configuring an application. The system comprises an estimation module configured to receive information that specifies a set of multiple states with which the application is associated during execution, receive information that specifies whether each of one or more program modules is active during respective states, at least some of the program modules having multiple instantiations configured to execute with different performance characteristics, and receive information that specifies performance characteristics associated with the multiple instantiations for each of at least some program modules that have multiple instantiations; and a configuration module configured to select one of the instantiations for each program module that has multiple instantiations based on at least one performance criterion associated with the application that depends on whether the program modules are active in respective states.

Aspects of the invention may include one or more of the following features.

The method further comprises forming an objective function based on a combination of measures of performance characteristics associated with the application.

The method further comprises minimizing or maximizing the objective function based on the selection of one of the instantiations for each program module that has multiple instantiations.

Minimizing or maximizing the objective function comprises minimizing or maximizing the objective function subject to one or more constraints.

At least one of the constraints comprises a budget that constrains a value of one of the measures.

The objective function comprises a linear combination of the measures.

The linear combination comprises a weighted sum in which a value of each measure is multiplied by a weight coefficient between zero and 1.

The performance criterion comprises a measure of a performance characteristic associated with the application that includes a sum over the set of states.

The performance criterion comprises a measure of a performance characteristic associated with the application that includes an extremum over the set of states.

The performance criterion comprises a measure of a performance characteristic associated with the application that includes a sum over multiple program modules.

The performance criterion comprises a measure of a performance characteristic associated with the application calculated based on a matrix that indicates which modules are active in a given state.

A first dimension of the matrix corresponds to the number of modules and a second dimension of the matrix corresponds to the number of states, and elements of the matrix are nonzero if a module indicated by the first dimension is active in a state indicated by the second dimension and are zero otherwise.

The second dimension is ordered so that consecutive elements correspond to consecutive states.

Selecting one of the instantiations for each program module that has multiple instantiations comprises: identifying multiple groups of at least two program modules that are active in a single state or in a group of multiple consecutive states, each group corresponding to a submatrix of the matrix; and selecting instantiations iteratively based at least in part on the submatrices.

The performance characteristics associated with the instantiations include a program size of an instantiation of a program module.

The performance the performance criterion comprises a measure of a program size of the application for a given selection of an instantiation for each program module that has multiple instantiations.

The measure of the program size of the application for a given selection of instantiations comprises a sum of program sizes of selected instantiations.

The performance characteristics associated with the instantiations include an amount of memory used by an instantiation of a program module during execution.

The performance the performance criterion comprises a measure of an amount of memory used by the application for a given selection of an instantiation for each program module that has multiple instantiations.

The measure of the amount of memory used by the application for a given selection of instantiations comprises a sum of amounts of memory used by selected instantiations of active program modules in a given state.

The measure of the amount of memory used by the application for a given selection of instantiations comprises a maximum of the sum over the states.

The performance characteristics associated with the instantiations include a time delay associated with a type of response from an instantiation of a program module in response to a user input.

The application is configured to execute on a client that communicates with a server in response to the user input.

A response from the instantiation of the program module is based at least in part on information received from the server.

The time delay depends on a bandwidth associated with a connection between the client and the server.

The time delay depends on an amount of memory used by the instantiation of the program module.

The time delay depends on a state with which the application is associated during execution of the instantiation of the program module.

Each instantiation of a program module is associated with no more than one type of response to user input.

At least one instantiation of a program module is associated with multiple types of response to user input, each type associated with a corresponding time delay.

The method further comprises categorizing different types of responses to user input and associated response times into groups.

The different types of responses are categorized into groups according to associated computational requirements, memory requirements, and data access requirements.

The application comprises a multi-threaded application in which at least some program modules include multiple threads.

The set of multiple states includes states from which the application is able to interact with a user.

At least some of the states are associated with one or more options presented to the user.

At least some of the states are associated with a budget that constrains a measure of a performance characteristic associated with the application.

At least one measure constrained by a budget associated with a state comprises a sum over program modules that execute in the associated state.

The application corresponds to a plurality of program modules related according to a hierarchical structure that is arranged so that fewer than all of the program modules are active in a given state.

The hierarchical structure is arranged so that no more than one program module at a given level of the hierarchy is active in a given state.

Aspects of the invention may include one or more of the following advantages.

The content delivery system can be configured to take into account performance constraints when delivering and presenting multimedia content to mobile devices. For example, a mobile device may have memory and computational constraints, and/or may be connected to a bandwidth-constrained wireless network.

Techniques for configuring server and/or mobile client operating characteristics such as communication protocol requests, operating modes of program modules, or content increase responsiveness of the system to the user.

The techniques enable methods of developing multimedia search, browse, and playback applications optimized for specific devices or classes of devices and for bandwidth-constrained networks, and optimized presentation of multimedia data on portable devices.

The techniques provide a procedure for focusing development efforts on improving those operating characteristics that would otherwise contribute most to decreasing the responsiveness to the user or decreasing the quality of the rendered content.

Other features and advantages of the invention will become apparent from the following description, and from the claims.

### DESCRIPTION OF DRAWINGS

FIG. 1 is a block diagram of a content delivery system.

FIG. 2 is a block diagram of a configuration system.

FIG. 3 is a block diagram of a server application.

FIG. 4 is state transition diagram for a media application.

FIG. 5 is Request Attribute Table.

FIG. 6 is a flowchart for an optimization procedure.

FIG. 7 is a table of sorted requests.

FIG. 8 is a block diagram of a client application.

FIG. 9 is a block diagram of a library of program modules.

FIG. 10 is a graphical representation of rows in an activity matrix.

FIG. 11 is a table of user input categories.

FIG. 12 is an activity matrix.

FIG. 13 is a block diagram of a wireless communication system.

### DETAILED DESCRIPTION

Overview

The number of mobile devices is increasing at a rapid rate. Mobile devices that are wirelessly connected to a network provide access to a large variety of data sources. Some mobile devices can access the internet just as easily as a desktop or laptop computer. However, most mobile devices are not as computationally powerful as a desktop or laptop computer. Some characteristics of a content delivery system, including software for a server and mobile client device, can be configured to take into account the lower computational power (e.g., processing speed), the smaller display screen size, and the smaller speaker size of mobile devices. A configuration system can perform various procedures (e.g., optimization procedures) to prepare the server and/or client device to provide a rich and responsive user experience.

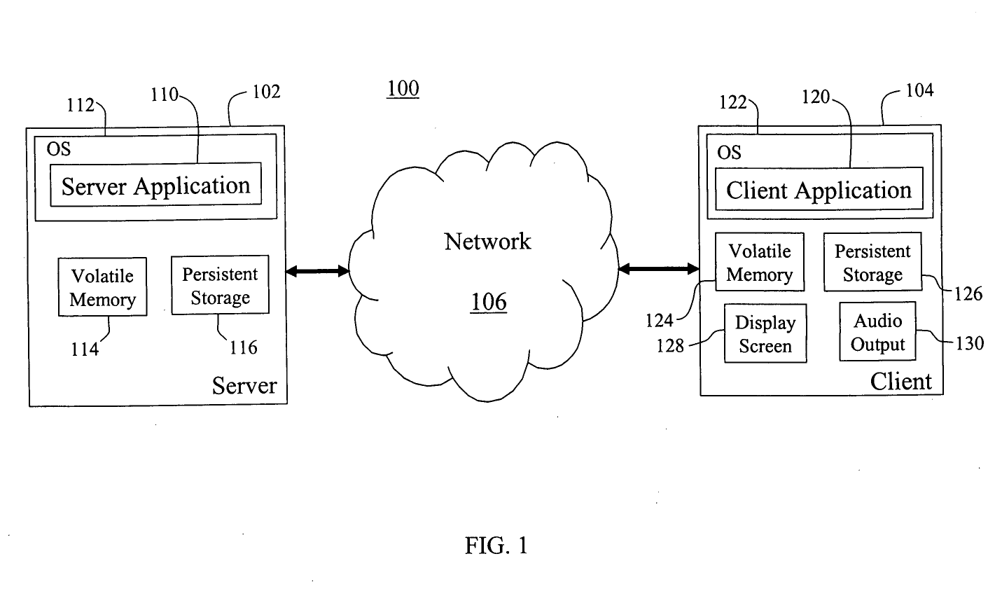

Referring to FIG. 1, a content delivery system 100 includes a server 102 that communicates with a client 104 (e.g., a mobile device) connected over a network 106. The content delivery system 100 can include interactive media capabilities including discovery, delivery, and/or playback of content, and can facilitate various interactions and transfer of information between the server 102 and the client 104 (or user of the client 104). The client 104 can be a portable device such as a mobile phone, a Personal Digital Assistant (PDA), or a smart phone, for example. The server 102 includes a server application 110 that includes one or more computer program modules that run within the operating system (OS) 112 on the server. The program modules can include modules that implement communication protocols, modules that search for and provide access to content (e.g., from a content catalog), and modules that configure content before it is provided to a client, for example. The server application 110 has access to volatile memory 114 (e.g., random access memory or RAM) and persistent storage 116 (e.g., hard disk storage).

The client 104 includes a client application 120 that includes one or more computer program modules that run within the OS 122 on the client 104 (e.g., Java (J2ME), BREW, Symbian, or Windows Mobile). The program modules can include modules that implement communication protocols, and modules for browsing and playing content, for example. The client application 120 has access to volatile memory 124, persistent storage 126, a display screen 128, and an audio output 130 (e.g., a speaker) on the device. The client 104 can also include any of a variety of types of user interfaces for receiving input from a user (e.g., keypad, pressure-sensitive screen, and/or microphone), depending on the type of device.

Data is transferred between the server 102 and the client 104 using a communication protocol for handing request and delivery of content objects (or “content object protocol”). The client 104 sends a content object request to the server 102, and in response the server sends content object data to the client. Content object requests can include arguments passed to the server 102 that specify the content to be included in the content object data (e.g., a song request can include an argument that specifies the title of the song requested). The server application 110 and client application 120 include program modules to configure messages and data to be transferred according to the content object protocol.

Applications for the client 104 can be characterized by various performance characteristics, such as program size, the amount of memory used to run the program, and the time that elapses in responding to various user inputs. The time to respond to user input can be characterized according to computational delays and delays in accessing data stored on the device (e.g., in volatile memory or persistent storage) or downloaded or streamed via a network connection (e.g., to a local area network, a wide area network, or the internet). The fastest response times involve, for example, low computational delays and access to data in local memory. The slowest response times involve, for example, high computational delays (e.g., decrypting and decompressing a video file), or access to data on the internet with a low-bandwidth connection, or both.

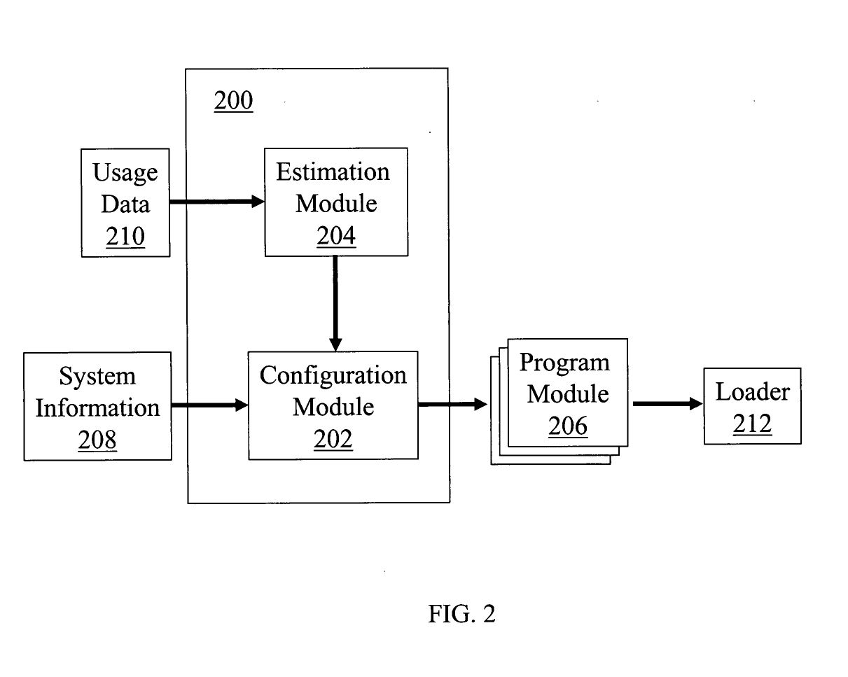

Referring to FIG. 2, a configuration system 200 includes a configuration module 202 (e.g., a software program running in a computing environment) that generates configured program modules 206 for the server application 110 and/or the client application 120 based on estimated attributes of a communication system. The configuration system 200 enables the interactive media discovery, delivery, and playback aspects of the content delivery system 100, for example, to be configured to improve performance and responsiveness to a user by configuring different potentially inter-related aspects of the system. The server 102 can also configure content before it is provided to the client 104, such that the content is optimized for a given target device or class of devices, or such that the content has properties that enable the content delivery system 100 to deliver the content with increased responsiveness to the user.

An estimation module 204 receives usage data 210 representing resources used during operation of the communication system and estimates the attributes to be used for configuring the program modules 206. The usage data 210 may correspond to historical and/or statistical data compiled by the communication system (e.g., from logs of the communication system), or may correspond to predictions of expected resources that would be used by a system running the communication protocol in response to different possible communication protocol requests.

The estimated attributes can include attributes of client or server software and/or hardware or attributes of a network over which the client and server are to be connected. For example, the attributes can include computational delays, transfer delays, or memory usage for different types of requests, or for different possible instantiations of program modules. The configuration module 202 determines budgets for the attributes based on system information 208 characterizing the capabilities of the server 102, client 104, and network 106, which can include information from a user about what the budgets should be.

In some implementations, the configuration module 202 configures existing program modules, and in other implementations, the configuration module 202 generates new configured program modules. An optional loader 212 loads the configured program modules 206 into a server 102 or a client 104. The configuration system 200 can store program modules, for example, as individual source or executable files or compiled into server applications or client applications, to be loaded into a server 102 or client 104 locally, or to be downloaded remotely. In some cases, a client application module is dynamically downloaded to a client device according to characteristics of the device or the network over which the client device is connected to the server 102.

In an example of an interaction between a client 104 and server 102 in a configured system, the client device runs an application program that includes a program module for playing video content. The application may include other program modules for activities such as browsing available content or purchasing content, for example. The application transitions among multiple program states related to presenting various screens and performing other interactions with a user.

The system can be configured to select different possible implementations of the client 104, the server 102, and the communication protocol. The selections can be made to improve the experience of a user of a given device in a given network environment. The system can be configured so that the user experiences reduced delay (or increased responsiveness) after interacting with the device to transition among the states.

For example, one group of states may correspond to a hierarchy of screens of a browser program module presented to a user for selecting a music video to be played on the device. A user may select an option to receive a list of popular music videos. Before selecting a particular music video, the user may play a clip to preview several of the music videos. When the user selects a music video, the content is streamed or downloaded to the client device for presentation to the user.

One way to configure the system includes grouping potential requests that can be made from the client to the server to anticipate choices of a user. In some implementations, a client application makes a request to the server 102 after each transition from one state to another. If the user selects an option to browse music videos that are available, the protocol may be configured to send a request for both a list of genres corresponding to the next application state and a list of popular videos corresponding to a subsequent application state that the user may potentially trigger. In the case that the user does not ask for the list of popular videos, since the amount of data involved is small, not much additional delay has been experienced by transferring the list. In the case that the user does ask for the list of popular videos, the responsiveness has been increased since the list does not need to be downloaded from the server 102 after the user asks for the list.

Another way to configure the system includes selecting content pre-processing and instantiations of program modules well-suited to the device and/or network capabilities. For example, if the client device is a wireless device roaming in an area without a high-bandwidth digital connection and the device has sufficient computational capabilities, the loader 212 may select highly a highly compressed version of a music video and may dynamically transfer an application module configured for playing highly compressed content. There may also be different versions of a music video for different devices, for example, to compensate for different display screen characteristics (e.g., differences in contrast or color reproduction). A particular client device can be pre-loaded with a particular program module instantiation based on capabilities of the device and an anticipated network environment. A combination of factors can be used to configure the system in various situations. In the description that follows, examples of configuring a content object protocol, client applications, content, and any combination of system aspects, is described in more detail.

The Content Object Protocol

The client application 120 communicates with the server application 110, for example, to present audio and video content to the user or in order to present a list of content that is available for presentation to the user. The user can search, browse, or playback multimedia content on the client 104 within an appropriate program module of the application 120. The content object protocol affects the responsiveness of the client application, for example, whenever the client needs to retrieve data from the server. The program modules on the server 102 and client 104 that communicate according to the content object protocol are configured to reduce communication delays and increase responsiveness. The content object protocol includes multiple layers of protocols, including network compatible, server compatible, and client compatible protocols. The network compatible protocols are typically specified by the network, but other portions of the content object protocol are configured to be compact and parsimonious such that client-server communication bandwidth and delays are reduced.

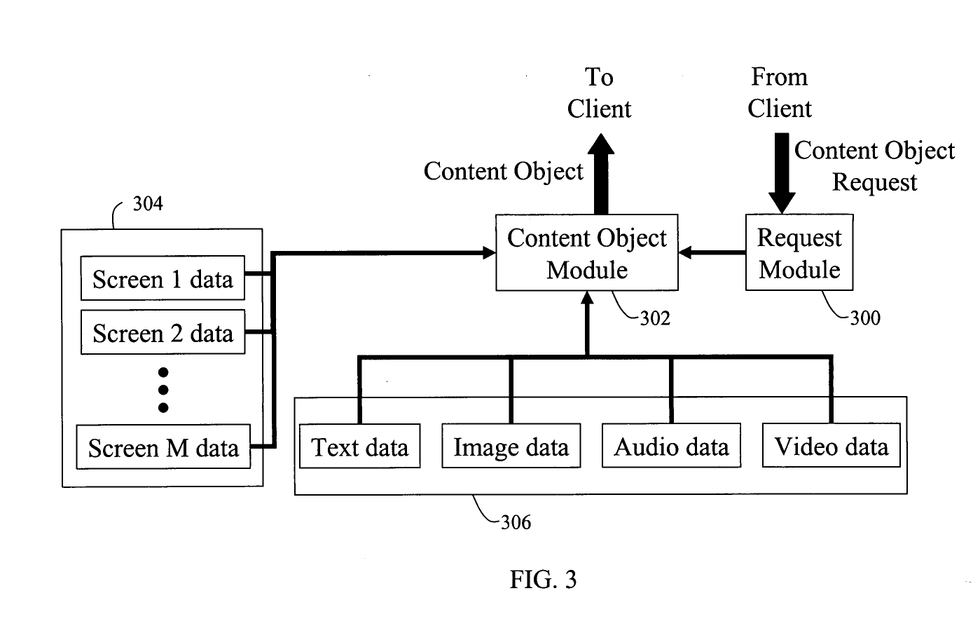

Referring to FIG. 3, program modules of the server application 110 include a request module 300 that receives content object requests from the client 104, and a content object module 302 that sends an assembled content object to the client 104. The client request module 300 processes the content object requests received from the client 104 and sends instructions to the content object module 302 for assembling a content object with the desired content.

The content object module 302 retrieves interface data 304 including, for example, data related to rendering screens presented to the user, and content data 306 including, for example, text data files, audio data files, image data files, and video data files. The data related to rendering screens presented to the user may include text data, audio data, image data, video data, and instructions and parameters for rendering the screen content. The assembled content object can include either or both the interface data 304 and the content data 306, depending on the request and the available content. In response to a single request, the content object module 302 may assemble a content object that includes several different types of content. The content object module 302 sends the assembled content object to the client 104.

There are various types of delays that can be associated with various aspects of delivering and presenting content to a user of the client 104.

There is a delay associated with establishing a connection between the server 102 and client 104 over the network 106. For example, it can take several seconds or more to establish a HyperText Transfer Protocol (HTTP) connection over a wide area network. In some implementations, the content object protocol is configured to reduce the number of new connections established between the client and the server so that the connection delays are reduced.

There is also a delay associated with a request to the server 102 from the client 104. The length of delay depends on what the server 102 needs to do in response to the request. Also, there can be a delay associated with a request to the client 104 from the server 102. Such delays are referred as request processing delays.

There are also communication delays associated with transferring data. Once a connection is established and a request is processed by the server 102, data are transferred between the server 102 and the client 104 at a rate that is determined by the network bandwidth. For example, if the network bandwidth is 10,000 bytes per second then it will take 10 seconds to transfer 100,000 bytes between the client and the server. However, if the 100,000 bytes could be compressed to 10,000 bytes, then it would only take 1 second for the transfer. In some implementations, the content object protocol is configured to reduce the number of bytes that need to be transferred between the client 104 and the server 102.

Configuring the Content Object Protocol

The configuration system 200 can generate a configured client request module 300 for the server 102, and corresponding program module for the client 104, to implement a content object protocol that reduces delays to provide increased responsiveness to a user. The configuration module 202 is able trade off different attributes that affect delay times to reduce delays associated with various requests. In some cases, the configuration module 202 optimizes program module characteristics based on a metric that represents weighted contributions from multiple attributes.

The configuration module 202 can incorporate a tradeoff between reducing the number of new connections, reducing the number of requests, reducing the number of bytes transferred per connection, and reducing the number of bytes transferred per request. For example, one approach to reducing the number of new connections is to use a single connection, keep that connection open until the application terminates, and make multiple requests through that single open connection. While maintaining an open connection and making multiple requests through a single connection is feasible in some situations, a large number of users would lead to a large number of open connections and could potentially overburden the server 102. Another approach to reducing the number of new connections is to use a single connection to transfer all possible data needed by the application in a single download. This option is viable if (1) the connection has a very large bandwidth, (2) the application requires the transfer of a very small amount of data, or (3) the application can parse and use the data before the download completes.

One approach to reducing the number of bytes transferred per connection is to simply limit the number of bytes transferred to a single byte or to a small number of bytes. In this case, the number of new connections will be so large that the user could spend a significant amount of time waiting for connections to be established. Another approach is to use a single connection and to reduce the number of bytes transferred per request by limiting the number of bytes transferred per request to a single byte or to a small number of bytes, and maintaining an open connection while making multiple requests.

In some implementations, the configuration module 202 generates program modules configured to perform an optimized content object protocol that balances the tradeoff between reducing the number of new connections, reducing the number of requests, reducing the number of bytes transferred per connection, and reducing the number of bytes transferred per request given the constraints of the network, the server, and the client. In some implementations, only one request per connection is permitted. In this case, the tradeoff can be made by a joint minimization of the number of new requests and the number of bytes transferred per request. Other implementations based on aforementioned approaches are possible.

In some implementations, the configuration module 202 determines how to optimize the content object protocol based on relationships between requests and program states of the client application 120. As the client application 120 executes on a client device, the application 120 transitions among various program states. Each program state may present a corresponding screen state on the device from which the program state can interact with a user.

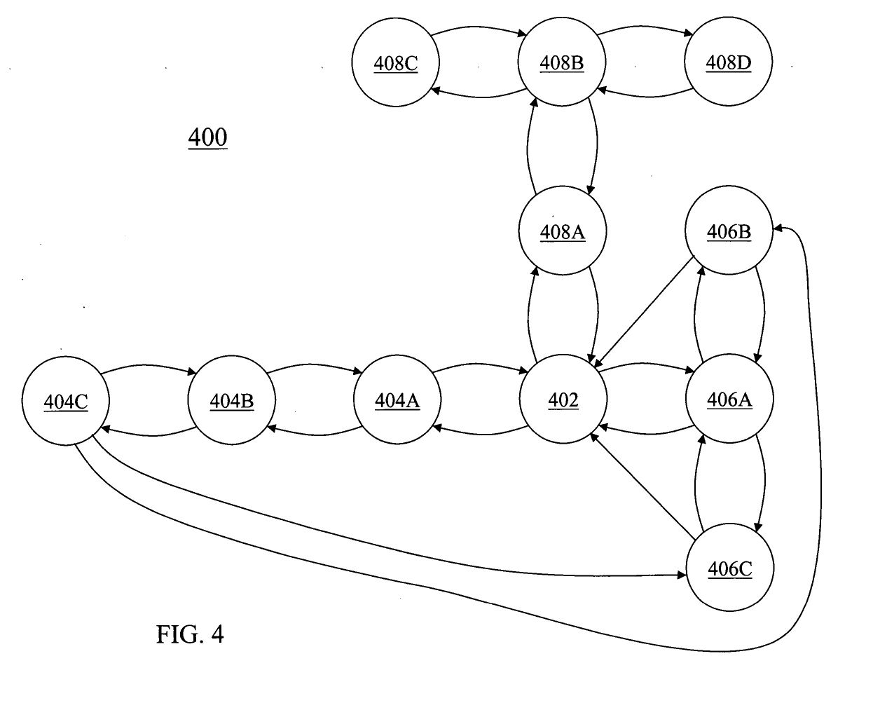

For example, referring to FIG. 4, a media application 400 running on a client device, such as a smart phone, presents various screen states to a user including a home state 402, media browser states 404A-404C, media player states 406A-406C, and user preferences states 408A-408D. From a given state, the user can provide user input (e.g., a button press, a screen tap or drag, a voice command, etc.) to select among various options presented to the user in the screen state (or otherwise associated with the screen state). Other examples of media applications can include any of a variety of other interactive functions, such as a media capture function for uploading recorded content from the client 104 to the server 102, for example.

In some cases, the user input triggers a transition to a different screen state. For example, from the home state 402, the user is able to provide input to transition to the media browser state 404A, the media player state 406A, or the preference state 408A. From these states, the user is able to navigate to other states or return to the home state 402. The user input provided to navigate among the user preferences states 408A-408D are local actions that do not trigger communication between the client 104 and server 102.

In some cases, the user input triggers a request from the client 104 to the server 102 (e.g., via a content object protocol program module in communication with or integrated with the media application 400). For example, user input provided to navigate among the media browser states 404A-404C may trigger requests to the server to retrieve, for example, data related to genres, artists, or songs for selection by the user. Some user input may trigger a request to the server 102 without triggering a screen state transition (e.g., to retrieve a next page of songs in a partial list of songs). If a user selects a song or video, the media application 400 transitions to a media player audio playback state 406B or video playback state 406C, and triggers a request for media playback. In some implementations, a content object protocol program module may first attempt to satisfy a request from a cache on the client 104, and then send a request to the server 102 upon a cache miss.

When a request related to a screen state or related to media playback is triggered by user input, there is a response time that corresponds to the time between the user input and an associated user presentation (e.g., presentation of a new screen state, or start of media playback). The response time can include, for example, the time for sending and processing request and response messages, data access delay, and computational delay.

Some client requests to the server 102 include requests related to screen states and other client requests include requests related to media playback, for example. In response to a request related to a screen state, the server 102 composes a Content Object that can include the text, images, audio, video, and/or instructions for rendering and manipulating objects on the screen, according to the request. In response to a request related to media playback, the server 102 composes a Content Object that includes media content data and/or instructions or data related to media playback, according to the request. A Content Object may include data corresponding to multiple screen states and/or data corresponding to media playback.

The number of new requests to the server can be reduced by combining requests that are associated with multiple screen states and by anticipating user behavior. The configuration module 202 can configure program modules for an optimized content object protocol based on collected application usage data 210 that characterizes a users use of the application.

In response to a request related to a screen state, the server 102 sends data used to render one or more images to be displayed in response to user input. In response to a request related to media playback, the server 102 may send screen related data, media data, and/or links to media files. In a screen state associated with media download, more than one image may be presented to the user, or objects on the screen may move or appear to move during media download in order to occupy or distract the user and reduce the perceived download time. An amount of screen related data that can be sent within a specified time period in response to a screen state request can be determined and maximized. Similarly, for media playback requests, an amount of screen related data that can be sent along with the media data or links to media files within a specified time period can be determined and maximized.

A request from the client 104 to the server 102 is associated with a server response and a subsequent client response. The response to a request can be characterized by one or more attributes, including, for example, the server response computational delay, the server response memory usage, the client response computational delay, the client response memory usage, the amount of data that is accessed, the data access type, and the data access delay. The data access type may be, for example: local memory, local file system, local area network, or wide area network. The “click distance” (or “number of clicks”) between two screen states is the minimum number of transitions associated with user input that are traversed over any path from one screen state to the other. In some cases, the click distance from a first screen state to a second screen state is different than the click distance from the second screen state to the first screen state. For example, the click distance from the media browser state 404C to the audio playback state 406B is one, since there is a minimum of one user input transition to navigate from state 404C to state 406B. However, the click distance from the audio playback state 406B to the media browser state 404C is four, since there is a minimum of four user input transitions to navigate from state 406B to state 404C.

Certain screen states can be grouped together into a set of screen states in order to decrease the response time to the user inputs. Screen states that display progress during the download of media data or during the initial loading of streaming media data typically have a large response time to a click corresponding to a media playback request. In some implementations, screen states are grouped according to their click distance and the Content Objects associated with requests triggered from user input are sent to the client 104 as a group.

The configuration system 200 can configure the content object protocol to group potential types of requests associated with different screen states to anticipate user selections and increase apparent responsiveness to the user. The content object protocol can be configured to recognize different requests that previously represented separate requests, for example, by constructing a new data structure format (e.g., XML structured data) that is recognized by the protocol.

In one approach to optimization of the content object protocol the configuration system 200 generates configured program modules as follows. The configuration module 202 receives the estimates of attributes associated with different requests available in the content object protocol. The server and client computational delay attributes for a request q are denoted by c_{q}^{s} and c_{q}^{c}, the server and client memory usage attributes for a request q are denoted by m_{q}^{s} and m_{q}^{c}, the number of bytes that are transferred in response to a request q is denoted by n_{q}, and the delay associated with transferring data for a request q is denoted by d_{q}. The configuration module 202 determines budgets for each of these attributes based on system information 208 characterizing capabilities of the server 102, client 104, and network 106.

The configuration module 202 ensures that each of the attributes satisfies the budget requirements. A developer using the configuration system 200 to provide configured program modules may optionally adjust some parameters to ensure that the budget requirements are met. Requests for which the difference between an attribute value and the corresponding budget value is greater than zero do not satisfy the budget requirements and the responsiveness of such requests are either improved in order to meet the budget requirements or the budget requirements are adjusted.

The configuration module 202 configures the content object protocol program modules to reduce the usage of system resources to increase the overall responsiveness of the system to a user. The configuration module 202 uses a combined metric to determine the overall resources such as computation time, network bandwidth, working program memory, and data storage memory used by the communication protocol in response to a request. A resource usage estimate is computed from the attributes to distinguish requests that have high attribute values (and thus use more resources) from those that have low attribute values (and thus use fewer resources).

First, the attribute values are normalized based on maximum values obtained from the usage data 210. For a given attribute value, the configuration module 202 determines the maximum attribute value across all requests and divides the attribute value by the maximum attribute value. For example, if the maximum data access delay is d_{q}^{max}, then the normalized attribute value is d_{q}/d_{q}^{max}. Before normalization, the delay attribute values are given in seconds and the memory usage attribute values are given in kilobytes. After normalization, the attribute values are unitless numbers in the range [0,1]. Alternative normalization procedures are possible.

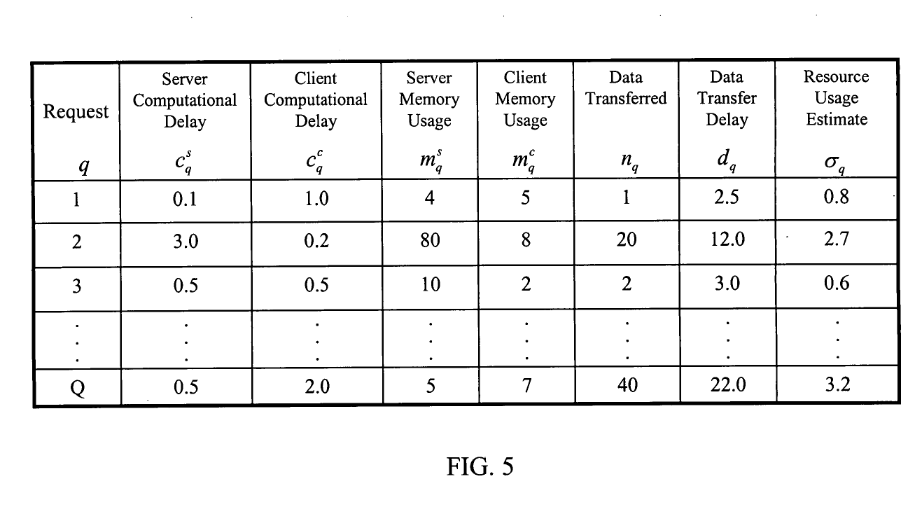

The configuration module 202 stores attribute estimates corresponding to each possible request in the content object protocol in a Request Attribute Table. The Request Attribute Table lists for each request q, the attributes c_{q}^{s}, c_{q}^{c}, m_{q}^{s}, m_{q}^{c}, n_{q}, and d_{q}. The estimation module 208 estimates the attributes based on the usage data 210, and is able to update the estimates as more application usage data 210 is collected. FIG. 5 shows an example of several rows in a Request Attribute Table. The last column is the resource usage estimate, which is a weighted sum of normalized attribute values, denoted by σ_{q}. Other procedures for computing the resource usage estimate are possible.

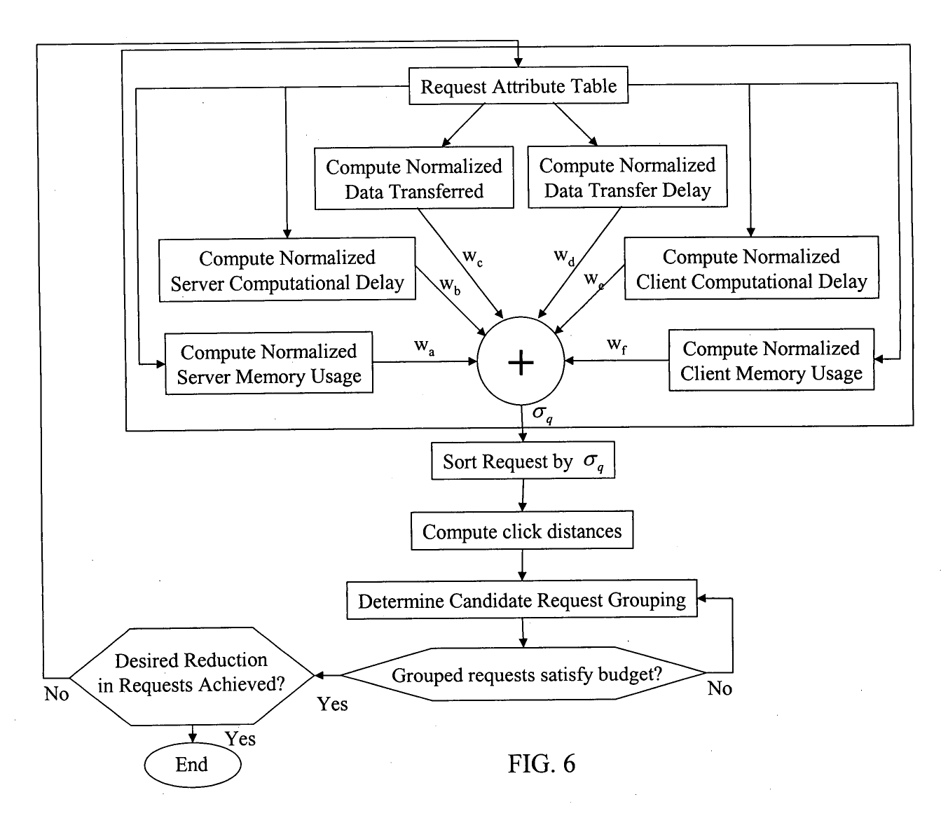

FIG. 6 shows an exemplary optimization procedure 600 for combining requests to reduce the number of separate requests from the client 104 to the server 102. The procedure 600 repeats until a desired criterion is achieved, such as a desired reduction in the number of separate requests. The procedure 600 determines 602 the resource usage estimate σ_{q} for each attribute, by computing the sum of the product of attribute weighting factors wₐ . . . w_{f} and the normalized attribute values for each request and storing this additional attribute σ_{q} in the Request Attribute Table. The weighting factors can be used to de-emphasize one or more attributes relative to others. Equal emphasis is achieved by setting all attribute weighting factors to unity.

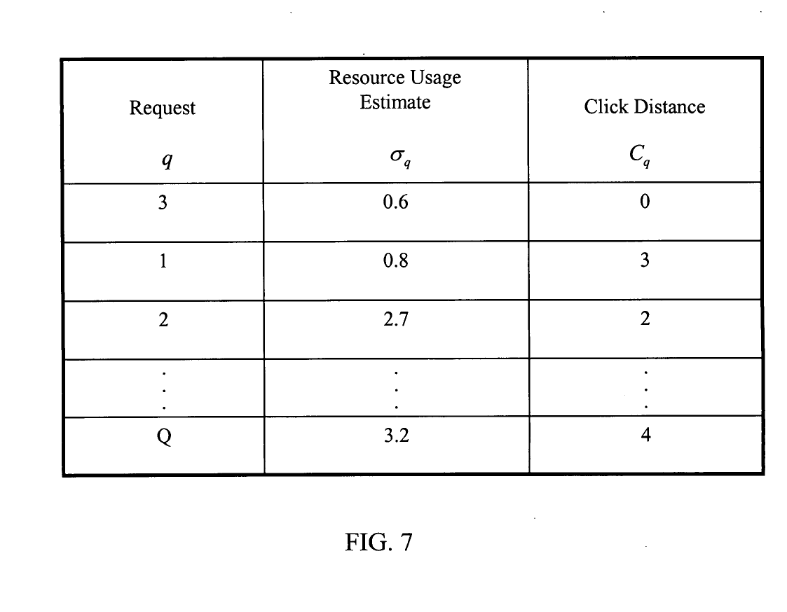

The procedure 600 sorts 604 the requests in ascending order according to their resource usage estimate σ_{q}. Each request is associated with at least one screen state from which the request is able to be transmitted. The procedure 600 determines 606 the minimum click distance from a state associated with the request with the lowest resource usage estimate to a state associated with each of the other requests. The procedure 600 determines 608 a candidate request grouping by grouping the request with the lowest resource usage estimate with a request having an associated state with the lowest click distance. If more than one request is associated with a state with the lowest click distance, then the procedure selects the one having the lowest resource usage estimate. The procedure 600 re-estimates the attributes for a potential combined request that includes both of the grouped requests based on the individual attributes for both requests, as described in more detail below. FIG. 7 shows an example of the requests from the Request Attribute Table in FIG. 5 sorted according to resource usage estimate, with click distances. The click distance associated with the first request (request 3) is zero since a screen state associated with request 3 is the reference state from which the other click distances are measured.

The procedure 600 determines 610 whether to store a single combined request to replace the two grouped requests in a new Request Attribute Table based on whether the combined request would satisfy the budget requirements. If the candidate request grouping does not cause any of the re-estimated attribute values for the combined request to exceed the budget value for that attribute, then the combined request is added to the Request Attribute Table. If the candidate request grouping does cause a budget value to be exceeded, then the procedure 600 selects another candidate request to group with the request having the lowest resource usage estimate. The procedure 600 searches for another candidate request first according to the request associated with the lowest click distance, and second (as a tie-breaking criterion) according to the request with the lowest resource usage estimate.

The procedure 600 determines 612 whether a desired reduction in the number of requests is achieved (e.g., based on at least one performance criterion, such as whether a performance measure of the configured content object protocol is below a predetermined threshold), or whether no further grouping of requests satisfy the budget requirements. If either of these conditions is true, then the procedure 600 ends 614. If not, then the procedure 600 repeats using the new Request Attribute table.

The procedure 600 re-estimates the attributes for a potential combined request based on the individual attributes for both grouped requests using different procedures depending on which attribute is being re-estimated. The computational delays, number of bytes transferred, and the data transfer delay attributes are summed. The memory usage attribute of the combined request is the maximum value of the individual memory usage attributes.

When a click distance is calculated for two requests, and at least one of the requests is a combined requests, the procedure 600 can use any of a variety of techniques to select a reference request among the corresponding grouped requests. The reference request is then used for computing click distances. For example, the reference request can be the request that was associated with the largest click distance when the requests were combined. Alternatively, the reference request can be the request that was associated with the smallest click distance when the requests were combined. Alternatively, the request with the largest amount of data to be transferred and/or the largest transfer delay can be chosen as the reference request.

Other procedures can be used to combine requests, or to otherwise reduce or minimize a given performance measure of the configured content object protocol.

The performance of a configured content object protocol is, in some cases, dependent on the final number of requests (after generating the combined requests), and the resource usage estimates and click distances associated with the requests. One measure for quantifying predicted performance of the configured content object protocol is based on a linear combination of the final number of requests N_{q}, the sum (or average) of the resource usage estimates

$${\sum }_{q} {σ}_{q} ,$$

and the maximum of the click distances

$${max}_{q} ( {C}_{q} ) .$$

For example, one performance measure is

$${E}_{protocol} = {w}_{q} {N}_{q} + \frac{{w}_{σ}}{{N}_{q}} {\sum }_{q} {σ}_{q} + {w}_{C} {max}_{q} ( {C}_{q} )$$

where w_{q, w}_{σ}, and w_{C} are emphasis weights on the number of requests, the average resource usage estimate, and the maximum click distance, respectively. Lower values of this measure indicate higher performance. There is a linear dependence of this measure on the number of requests, but other functional dependencies are possible for other measures. There is a linear dependence of this measure on the average of all resource usage estimates, but other dependencies are possible for other measures, including the total, maximum, or the mode of all usage estimates, or some other statistic. There is a linear dependence of this measure on the maximum click distance; other statistics are possible for other measures. Alternative measures that include nonlinear functional dependencies on any or all of these three parameters are also possible. For example, for some applications a content object protocol performance measure may use a squared dependence on the number of requests. Or, as another alternative, some applications may be characterized by a content object protocol performance measure that includes a term that is the product of two or more of the parameters, such as the product of the number of requests and the maximum click distance.
Configuring Client Applications

Client applications can be configured to support reconfigurable user interface components without the need for rebuilding or re-compiling the application. The content delivery system 100 supports dynamic content, e.g., the ability to change content “on the fly.” Client applications can be configured based on at least one performance criterion, such as whether a performance measure of the configured content object protocol is below a predetermined threshold optimized by jointly optimizing performance characteristics such as program size, memory usage, and responsiveness to user input.

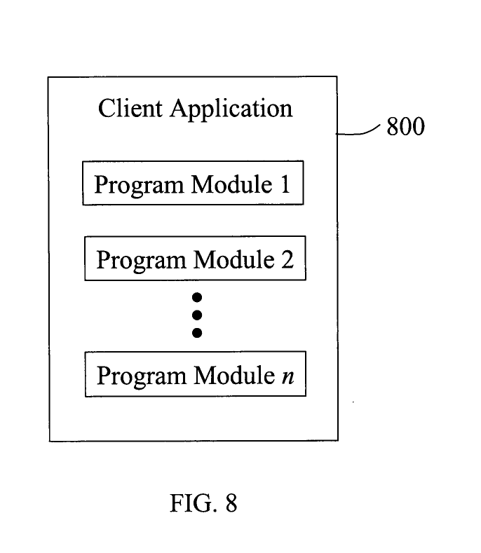

FIG. 8 depicts a client application 800 including program modules 1 . . . n. A client application is built from a library of program modules with measured or estimated performance characteristics. For example, the performance characteristics can be related to program size, memory usage, and responsiveness to user input. Other performance characteristics may be appropriate for some implementations.

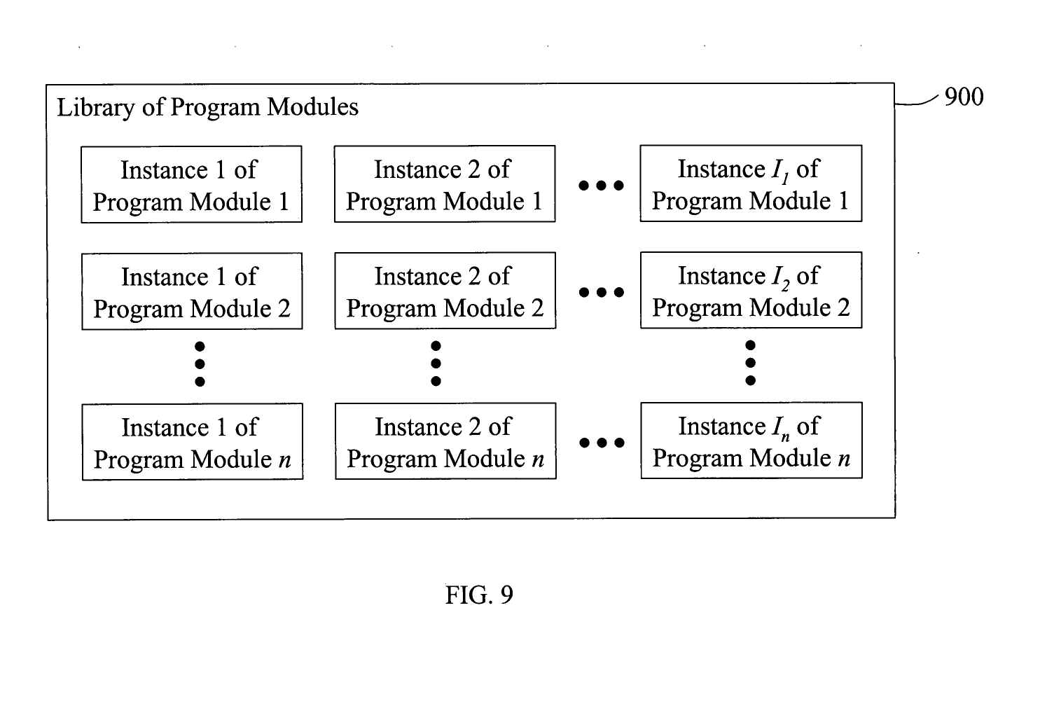

FIG. 9 depicts a library 900 of program modules. Each program module has one or more instantiations. For example, a program module can have three instantiations: one optimized for small program size, one optimized for low memory usage, and one optimized for low response times. If the response time characteristic involves communication across a network, the response time is provided as a function of network bandwidth and the application can be configured for a specified network bandwidth assumption. Measurements and constraints on the module size, the maximum memory required for each module, and the response times associated with user inputs are used to determine the optimal application configuration, i.e., the configuration that conjointly minimizes the performance characteristics. In addition, more specific constraints such as per screen program size, memory, and response time budgets can be taken into account in the configuration process. Target devices on which the client application will run are grouped into classes according to their capabilities, and the optimal client application configuration is determined for each class of target devices.

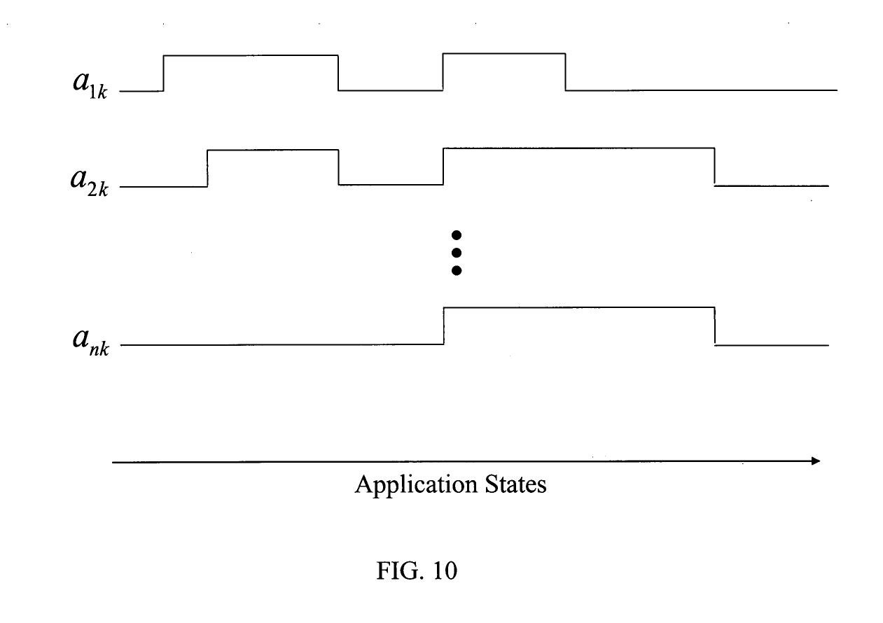

In an exemplary configuration process for the application 800, a set of required program modules is identified along with the program size, memory usage, and response time characteristics for each module. A main program for the application 800 is also treated as a program module. Each program module may have several different instantiations. Each instantiation of module i has associated with it an instantiation index Jᵢ, and the set of instantiation indices for all modules will be denoted by J, i.e., J={J₁,J₂, . . . ,Jₙ}. The application 800 has associated with it K states, and at any time while the application is executing the application is in an identifiable and observable state k. In practice, the number of states of an application may be quite large. Let aᵢₖ denote the activity of module i at state k. The activity aᵢₖ is a binary variable with a value of 0 or 1, i.e., a module is either active (aᵢₖ=1) or inactive (aᵢₖ=0). The module activity matrix, denoted by a, indicates which modules are active in any state. FIG. 10 provides a graphical representation of several rows in an exemplary activity matrix.

The number of states and the identity of each state of an application can be determined by executing the application with each distinct set of possible user inputs and identifying which modules are active at any time. States are identified by changes in the number of modules that are active or changes in memory usage. Alternatively the configuration process can use a pre-defined set of states.

The number of states associated with multi-threaded applications is determined by the number of states for each thread. If the threads are independent, then the number of states is the product of the number of the states for each thread. If the threads are dependent, then the number of states is less than the product of the number of states for each thread because the dependence constrains the number of possible states. The total amount of memory used by a multi-threaded application generally depends on the number of active threads at any give time.

Hierarchical application design tends to simplify the determination of the number of states and tends to make the activity matrix sparse or reduced in rank. Hierarchical application design in this context includes the reduction of the number of active modules for any given state. For example, the application can include program modules related according to a hierarchical structure that is arranged so that fewer than all of the program modules are active in a given state. In some cases, the hierarchical structure is arranged so that no more than one program module at a given level of the hierarchy is active in a given state. As will be shown, hierarchical application design will tend to reduce the complexity of the optimization procedure.

Let the program size of instance j of module i be denoted by sᵢⱼ. The program size is a simple performance characteristic to measure because it is independent of the application state and memory usage.

The memory usage of a module can be a bit more difficult to measure because the memory usage may be state dependent. To incorporate state dependence, the memory usage within each state is measured. Let the memory usage of instance j of module i in state k be denoted by mᵢⱼₖ. Let Mₖ(J) be the total memory used by the application in state k given the choice of instantiations implied by J, the instantiation index set. The total memory in use by the application in any state k is the sum of the memory used by all active modules in that state, i.e.,

$${M}_{k} ( J ) = {\sum }_{i = 1}^{n} {a}_{ik} {m}_{{iJ}_{i} k} .$$

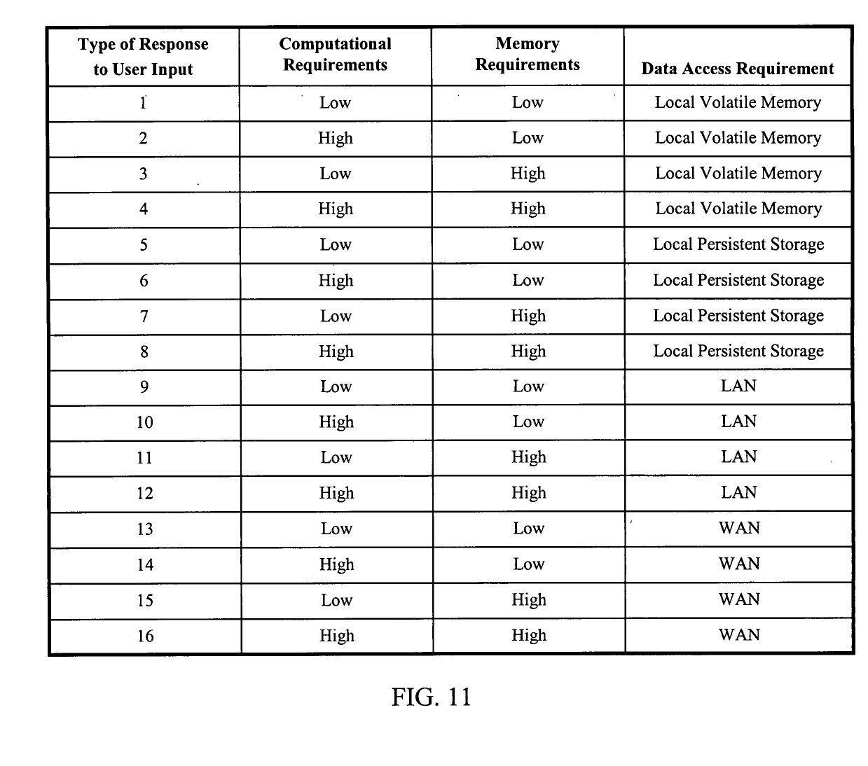

The response time of a module may be the most difficult performance characteristic to measure because it may be dependent on the application state, the memory usage of the application, the network bandwidth, or on all three. The response time is also dependent on the computational capabilities of the device and the software environment (e.g., operating system) on the device. The application 800 can be optimized for each device and software environment. Modules may be restricted such that only one type of response to a user input occurs per module and, correspondingly, only one response time needs to be measured per module. In practice there may be multiple types of responses to user inputs per module and, correspondingly, multiple response times per module. However, user inputs can be categorized into several groups and, correspondingly, the response times can be categorized into the same number of groups. Types of responses to user inputs and response times can be categorized according to their computational requirements, memory requirements, and data access requirements, and one response time performance characteristic can be defined for each category. An exemplary table of (sequentially numbered) categories of types of responses to user inputs are shown in FIG. 11. Alternative examples might make use of alternative groupings or might use more categories. In the following example, only one response time is defined per module.

The dependence of the response time of instance j of module i on the total memory usage in state k is denoted by rᵢⱼₖ(Mₖ). The response time may also be a function of the network bandwidth at a given time at which the application is in a given state k, Bₖ, i.e., rᵢⱼₖ=rᵢⱼₖ(Bₖ), if the response requires downloading or uploading data from or to a server, for example. (A case in which the download bandwidth is different from the upload bandwidth is also possible.) In general, the response time is a function both the total memory usage and the network bandwidth, i.e., rᵢⱼₖ₌ᵣᵢⱼₖ(Mₖ,Bₖ). The functional dependence of the response time on total memory usage and network bandwidth is assumed to be separable, i.e., rᵢⱼₖ(Mₖ,Bₖ)=f(Mₖ)g(Bₖ). The functional dependence of the response time on total memory usage is directly proportional to the total memory usage, i.e., increasing memory usage leads to increased response times. This dependence is typically nonlinear. In some implementations the dependence of the response time on the total memory usage is measured for each total memory usage value. Alternative implementations employ several other functional dependencies. The functional dependence of the response time on network bandwidth is inversely proportional to the network bandwidth. In practice, the time dependency of network bandwidth is often unknown. In some implementations the expected network bandwidth is used, i.e., Bₖ is set to E[Bₖ]=B, and the dependence on network bandwidth is modeled by g(B)=g₀B⁻¹+D , where D is a delay associated with establishing a network connection. If the network bandwidth is in units of kilobits per second and the delay is in units of seconds, then g₀ is 1 kilobit.

With these definitions, the performance of an application can be characterized by the instantiation index set, the activity matrix, the module sizes, the module memory usage, and the module response times. This set of application characteristics is denoted by A(J), i.e., A(J)={aᵢₖ,sᵢⱼ,mᵢⱼₖ,rᵢⱼₖ,Jᵢ;i=1,2, . . . , n;j=Jᵢ;k=1, . . . ,K}. Next, a set of performance measures and an optimization objective function is defined so that the best instantiation index set can be chosen such that the performance measures are optimized across all states, modules, and instantiations.

Various performance measures can be used to optimize the performance of an application. In some implementations, three performance measures are used: the total application size, the maximum memory usage of the application, and the overall responsiveness of the application. The total application size performance measure, denoted by S, is the total program size for a selected instantiation index set and is computed as the sum of the sizes of all program modules given J, i.e.,

$$S ( J ) = {\sum }_{i = 1}^{n} {S}_{{iJ}_{i}} .$$

The maximum memory usage of the application, denoted by M, is the maximum memory usage of the application across all states given J, i.e.,

$$M ( J ) = {max}_{k} \{ {M}_{k} ( J ) \} = {max}_{k} \{ {\sum }_{i = 1}^{n} {a}_{ik} {m}_{{iJ}_{i} k} \} .$$

The overall application responsiveness performance measure, denoted by R, is the sum of the response times for each module across all states given J, i.e.,

$$R ( J ) = {\sum }_{k = 1}^{K} {\sum }_{i = 1}^{n} {r}_{{iJ}_{i} k}$$

or more generally,

$$R ( J ) = {\sum }_{k = 1}^{K} {\sum }_{i = 1}^{n} {r}_{{iJ}_{i} k} ( {M}_{k} , B ) .$$

The optimization procedure minimizes these performance measures subject to the budgets for each of these measures.

There are several approaches to jointly minimizing the application program size, memory usage, and response times given maximum allowed values for each of these values. In some implementations, the following approach is taken. Let S_{b}, M_{b}, and R_{b} denote .the budget values for the application program size, memory usage, and response time, respectively. The objective function, E_{client}, representing an overall client application performance measure for the optimization procedure is E_{client}(J)=wₛS(J)+w_{M}M(J)+w_{R}R(J), where w_{S, w}_{M, and w}_{R} are emphasis weights for the program size, memory usage, and response time measures. If the three measures have equal emphasis, the emphasis weights are chosen to simply normalize the performance measures. For example, the program size is normalized to the maximum possible program size given the program sizes of all instantiations for each module. So if the three measures have equal emphasis, each term in the objective function will range from 0 to 1 and contribute equally. The goal of the optimization procedure is to find the instantiation index set that minimizes the objective function. The optimization procedure minimizes the objective function over all possible instantiation index sets J subject to the constraints S(J)≦S_{b}, M(J)≦M_{b}, and R(J)≦R_{b}. In some cases, the possible instantiation index sets J include all instantiation index sets, and in other cases the possible instantiation index sets include only a subset of the instantiation index sets (e.g., after removing instantiation index sets that are not compatible with certain constraints or options). If any of the performance measures associated with the optimal instantiation index set exceeds the budgeted value, then additional instantiations are required in order to satisfy those budget values. Thus, the terms in each of the application performance characteristic sums provide an indication of whether any of the program modules is contributing to poor performance characteristics.

The objective function can be written explicitly as

$$\begin{matrix}{E}_{client} ( J ) = {w}_{s} S ( J ) + {w}_{M} M ( J ) + {w}_{R} R ( J ) \\ = {w}_{s} {\sum }_{i = 1}^{n} {S}_{{iJ}_{i}} + {w}_{M} {max}_{k} \{ {M}_{k} ( J ) \} + {w}_{R} {\sum }_{k = 1}^{K} {\sum }_{i = 1}^{n} {r}_{{iJ}_{i} k} ( {M}_{k} , B ) \end{matrix}$$

Given the set of performance characteristics and emphasis weights, the performance measures and the objective function can be computed. The minimum objective function can be found by computing the objective function for each possible instantiation index set and choosing the set that minimizes the objective function and satisfies the performance budget constraints.

If no instantiation index set exists that satisfies all of the performance budget constraints, additional instantiations are used. The individual contributions to the performance measures by each module may be used to determine the modules for which additional instantiations will be most productive.

If there are L performance characteristics (e.g., L=3 for a single response time characteristic per module), n modules, I instantiations per module, and K discrete states, then the complexity of the optimization procedure is O[I(n+nK+LnK)]. If there are 16 types of responses to user inputs, then L=2+16=18. Although the complexity analysis above assumes the number of instantiations is the same for each module, this constraint is not necessary. The optimization procedure is applied to each target device or device class.

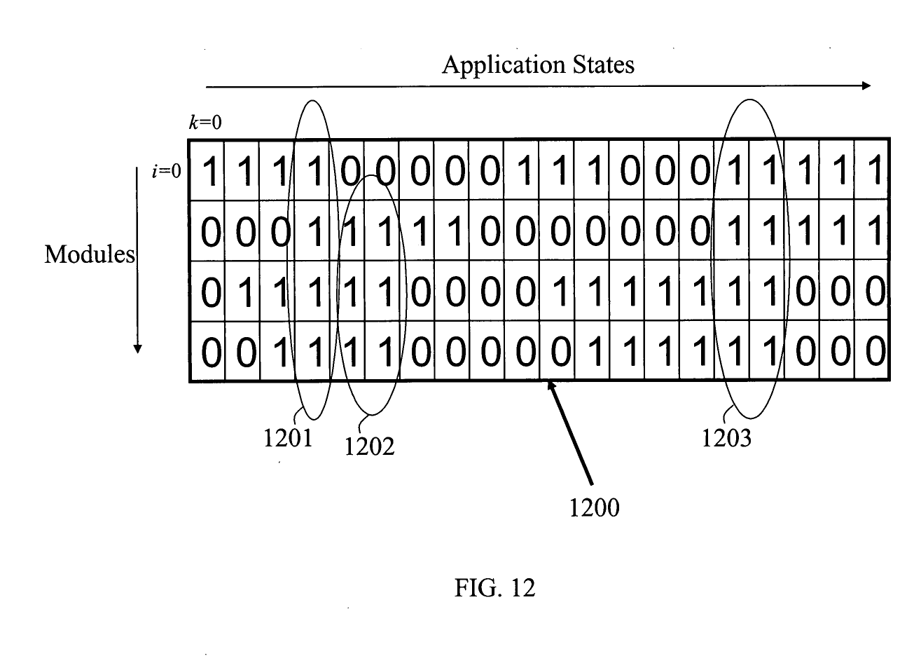

The hierarchical application design concept points the way toward an alternative iterative approach to optimization. In this alternative approach, the activity matrix is analyzed and clusters of modules in the same state are identified for optimization. This process of identifying and optimizing submatrices within the activity matrix is repeated until all modules and states have been optimized and a global minimum of the objective function is reached. FIG. 12 provides an example of an activity matrix 1200 in which three groups of modules 1201, 1202, and 1203 in a common state or two consecutive states are identified for optimization.

In an extension to the optimization procedure, each screen state that can be presented to the user within the application can be assigned a specific performance characteristic budget, e.g., the modules associated with generating each screen state may be assigned a maximum program size, memory, and response time. Such per screen state performance budgets serve as additional constraints on the solution. To implement this extension, the list of modules required to produce each screen state is used and performance measures are computed for each screen state by modifying the summations over the modules to include only those modules required to produce the screen.

Configuring Content

The server 102 can configure content before it is provided to the client 104, such that the content is optimized for a given target device or class of devices, or such that the content has properties that enable the content delivery system 100 to deliver the content with increased responsiveness to the user. For example, two exemplary types of content configuring are described below: audio content optimization, and video content optimization.

Audio

Optimizing audio content for the target device involves a tradeoff between audio quality, bit rate, and, in some applications, speed of encoding. The bit rate constraint may be determined by the network bandwidth or by the amount of memory or storage available on the target device. The amount of memory or storage available on the device may also require that the audio data be broken up into segments. One exemplary audio content optimization procedure assumes that the network bandwidth has been specified or determined prior to or at the time the media content is to be transferred, and that the amount of memory and storage available on the target device has been specified or determined prior to or at the time the media content is to be transferred. The optimization procedure achieves the highest audio quality given the bit rate constraint. In an alternative implementation, an additional constraint on the speed of encoding is taken into account.

Some cell phones are optimized for voice signals and are not optimized for music content. However, music content can be optimized for presentation on target devices by taking into account device speaker, audio decoder, and audio playback characteristics as well as data from listening tests. Volume normalization is employed to achieve consist volume levels for each piece of audio content. Alternatively, level-dependent companding of the sampled audio is employed to avoid low volume levels during playback.

The speaker on the device can be characterized by playing a test signal such as a linear chirp on the device and measuring the output from the speaker. The speaker output is compared with the original signal and the distortion introduced by the speaker is characterized. Typically, the speaker distortion characterization takes the form of a frequency response curve. This frequency response curve is taken into account when preparing audio content to be played on the device. For example, if certain portions of the frequency spectrum are characterized by a low response, those portions of the spectrum can be amplified in the signal that is to be played on the device. A compensatory filter is applied to the input signal so that the resulting signal to be played on the device will have the desired frequency response. The desired frequency response is enhanced in regions of low response (e.g., to compensate for poor speaker response) or attenuated in regions of excessive response (e.g., to avoid vibrational noise). Various types of compensatory filters can be constructed using digital signal processing techniques.

Data from listening tests may also suggest modifications of the response in certain portions of the spectrum for specific devices. For example, if most subjects report a deficient low frequency response, the compensatory filter is adjusted to produce higher response in the low frequency portion of the spectrum. In some implementations, if more than 75% of subjects report a characteristic that is common to most input signals and that can be compensated for, then the compensation is applied to all input signals.

In some implementations, the headphones that are shipped with the device, or a list of target headphones, are characterized using the same methods that were used with the speaker.

In some implementations, the audio formats compatible with the device are analyzed with respect to audio quality and bit rate. The audio format that produces the highest perceived quality at the target bit rate is chosen. In some cases, listening tests are performed to determine which audio format produces the highest perceived quality at the target bit rate.

An exemplary optimization procedure is as follows. A reference audio signal is chosen that represents the typical audio content that will be used. The reference audio signal is modified using methods such as compensatory filtering, compression, and companding. Each modified signal is characterized by a set of attributes. The attributes of the modified signals are: an objective quality measure, a subjective quality rating, and a modification processing delay. The objective quality measure is, for example, the segmental signal-to-noise ratio. A number of other objective quality measures could be used. Subjective quality ratings are obtained via listening tests in which subject(s) listen to the modified signals and rate them on a scale from −3 to 3, where 0 represents no difference from the unmodified signal. Alternatively, subjective quality ratings can be obtained based on relative ratings from a subject presented different modified versions of the signal. Subjective quality ratings are averaged across subjects if more than one subject is used. The values associated with the same attribute are normalized to be comparable with values associated with the other attributes. For example, the values are normalized by determining the range of values for each attribute and transforming the attribute values so that they are in the same range (e.g., from 0 to 1). In the case of the modification processing delay, the inverse of the modification processing delay is transformed into the [0,1] range. For each modified signal, the sum of all normalized attribute values is computed. The normalized attributes may be weighted to emphasize certain attributes more than others. The modified signal with the highest sum of normalized attribute values is chosen as the optimum modification process.

In some implementations, this optimum modification process is applied to all audio content. In other implementations, some fraction of the audio content that will be used in the application undergoes this optimization process. In some implementations, each piece of audio content is optimized using additional objective quality measures instead of the subjective quality ratings.

Video

Optimizing video content for the target device involves a tradeoff between video quality, bit rate, and, in some applications, speed of encoding. The bit rate constraint may be determined by the network bandwidth or by the amount of memory or storage available on the target device. The amount of memory or storage available on the device may also require that the video data be broken up into segments, exemplary video content optimization procedure assumes that the network bandwidth has been specified or determined prior to or at the time the media content is to be transferred, and that the amount of memory and storage available on the target device has been specified or determined prior to or at the time the media content is to be transferred. The optimization procedure achieves the highest video quality given the bit rate constraint. In an alternative implementation, an additional constraint on the speed of encoding is taken into account.

In some implementations, video quality is increased for presentation on target devices by taking into account the characteristics of the screen on the device, the video decoder if any, and the image rendering capabilities of the software environment as well as data from viewing tests. Luminance or gamma correction is used to compensate for display screens that tend to be dark or bright.

Some display screens do not accurately reproduce the colors specified in an image or video file. Various methods can be used for correcting color distortion introduced by displays including gamma correction and color transformation and matching. In some implementations, a color test image is used to adjust the colors using color matching.

Luminance contrast enhancement is a type of luminance modification that can be used to enhance the perceived image quality. Opponent color contrast enhancement is a type of color modification that can be used to improve the perceived image quality. In some implementations, luminance contrast enhancement and opponent color contrast enhancement are performed via opponent color center-surround shunt processing. Alternative implementations use other contrast enhancement methods.

In addition to luminance correction, color correction, luminance contrast enhancement, and opponent color contrast enhancement, frame rate modifications can be performed on video signals to enhance the perceived video quality during playback. Sometimes, for example, using a faster decoded frame rate has the effect of smoothing out pixelization artifacts that occur as a result of compression. In some implementations, frame rate reduction is performed by reducing the number of key frames. Some implementations subsample the number of frames in the original video or generate a reduced number of output frames as part of the compression process.

An exemplary optimization procedure is as follows. A reference video signal is chosen that represents the typical video content that will be used. The reference video signal is modified using methods such as luminance correction, color correction, luminance contrast enhancement, opponent color contrast enhancement, frame rate resampling, and compression. Each modified signal is characterized by a set of attributes. The attributes of the modified signals are: an objective quality measure, a subjective quality rating, and a modification processing delay. The objective quality measure is, for example, the peak signal-to-noise ratio. A number of other objective quality measures could be used. Subjective quality ratings are obtained via viewing tests in which subject(s) view the modified signals in a controlled environment and rate them on a scale from −3 to 3, where 0 represents no difference from the unmodified signal. Alternatively, subjective quality ratings can be obtained based on relative ratings from a subject presented different modified versions of the signal. Subjective quality ratings are averaged across subjects if more than one subject is used. The attribute values are normalized as described above, for example, by determining the range of values for each attribute and transforming the attribute values so that they range from 0 to 1. In the case of the modification processing delay, the inverse of the modification processing delay is transformed into the [0,1] range. For each modified signal, the sum of all normalized attribute values is computed. The normalized attributes may be weighted to emphasize certain attributes more than others. The modified signal with the highest sum of normalized attribute values is chosen as the optimum modification process.

In some implementations, this optimum modification process is applied to all video content. In other implementations, some fraction of the video content that will be used in the application undergoes this optimization process. In some implementations, each piece of video content is optimized using additional objective quality measures instead of the subjective quality ratings.

Performance Measure

The performance of the content configuration process is dependent on the sum of the normalized attribute values for each type of content (e.g., audio and video). One measure for quantifying the performance of the content configuration process is the linear combination of the sums of the normalized attribute values for each type of content. To make this performance measure consistent with the content object protocol and client application performance measures, the reciprocals of the sums are used so that lower values indicate higher performance. Other performance measures are possible.

System Configuration

The performance of the content delivery system 100 can be measured by combining the performance measures associated with the content object protocol, the client application, and the modified content. For example, a combined weighted system performance measure can be calculated as, e.g.:
E_{system}=w_{protocol}E_{protocol}+w_{client}E_{client}+w_{content}E_{content}
where lower values of the measure indicate “higher” or “better” performance. In other examples, the performance measures associated with different aspects of a system can be selected such that “higher” or “better” performance corresponds to higher values of a performance measure.

Thus, in general, when better system performance corresponds to a decrease in one set of measures (e.g., Eₐ, E_{b}) and an increase in another set of measures (e.g., E_{c}, E_{d}), a combined weighted system performance measure can be calculated using the reciprocal of each of the measures in either set, e.g., as:
E_{system}=wₐEₐ+w_{b}E_{b}+w_{c}E_{c}⁻¹_{c}+w_{d}E⁻¹_{d}
where better system performance corresponds to a decrease in E_{system}; or as
E_{system}=wₐE⁻¹ₐ+w_{b}E⁻¹_{b}+w_{c}E_{c}+w_{d}E_{d}
where better system performance corresponds to an increase in E_{system}.

Since the content object protocol, client application, and content configuration processes are interdependent, after a portion of the system is configured to reduce one of the performance measures, each of the other two performance measures are re-computed.

The system performance can be configured to reduce this combined performance measure, for example, by configuring different aspects of the system to reduce the content object protocol, client application, and content performance measures either in parallel or iteratively (e.g., in a round-robin sequence).

Network Environment

The network 106 over which the data stream is sent to the client 104 can be any type of network including, for example, wired, wireless, Bluetooth, personal area networks, local area networks, or wide area networks. Some wireless network architectures, such as General Packet Radio Service (GPRS), impose bandwidth limitations on communication systems. Such communication systems can benefit from the techniques described herein. Additionally, communication systems operating on networks with high bandwidth will benefit from the techniques described herein because such networks can have a lower effective bandwidth if there are an excessive number of users, a large number of users in a single cell, users are moving between cells, and/or the client and server communication path is blocked by structures such as buildings. The communications protocol used is compatible with the network 106.

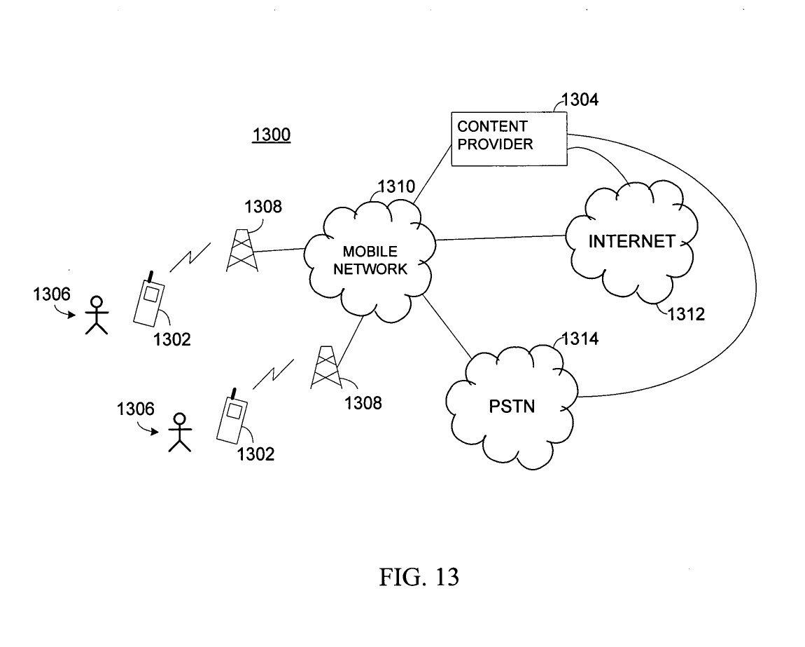

FIG. 13, shows an exemplary wireless communication system 1300 in which the content delivery system 100 could be used. The wireless communication system 1300 supports transmission of voice and data communication between a number of mobile devices 1302 (acting as the client 104) and a content provider 1304 (providing content from a server 102). Mobile devices 1302 are operated by mobile users 1306 and communicate over wireless links to base transceiver stations (BTS) 1308. The BTS 1308 are coupled to the content provider 1304 over a mobile network 1310, which provides a fixed network communication infrastructure for passing communication between the content provider 1304 and mobile devices 1302. The BTS 1308 may also be coupled to the content provider 1304 over communication infrastructure that includes other networks such as a data network, here over public Internet 1312, or a telephone network, here over Public Switched Telephone Network (PSTN) 1314.

Alternative Implementations

Many other implementations other than those described above are within the scope of the following claims. For example, even though specific content types may have been mentioned above, any of a variety of types of content can be included. Content types can include text, images, audio, and video. The text content may represent information related to image, audio, or video data, parameters for rendering the screen, or instructions for rendering the screen. Image content may include splash screens, artwork related to the audio or video content, artwork related to the multimedia application, artwork related to the content provider, or informational images. Audio content may include ringtones, segments of music tracks, full music tracks, interviews, sound effects, and informative announcements. Video content may include music videos, interviews, movie previews, game previews, and informative announcements. Video content may include video data without audio content or video and audio content.

Aspects of the techniques described above can be implemented using software for execution on a computer. For example, the software can include procedures in one or more computer programs that execute on one or more programmed or programmable computer systems. The computer systems include at least one processor, at least one data storage system (including volatile and non-volatile memory and/or storage elements), at least one input device or port, and at least one output device or port. The software may form one or more modules of a larger program.

The software may be provided on a medium, such as a CD-ROM, readable by a computer, or delivered (e.g., encoded in a propagated signal) over a network to the computer where it is executed. The software may be implemented in a distributed manner in which different parts of the computation specified by the software are performed by different computers. The techniques may also be considered to be implemented as a computer-readable storage medium, configured with a computer program, where the storage medium so configured causes a computer system to operate in a specific and predefined manner to perform the functions described herein.

What is claimed is:

1. A method for configuring an application, the method comprising:
receiving information that specifies a set of multiple states with which the application is associated during execution;
receiving information that specifies whether each of one or more program modules is active during respective states, at least some of the program modules having multiple instantiations configured to execute with different performance characteristics;
receiving information that specifies performance characteristics associated with the multiple instantiations for each of at least some program modules that have multiple instantiations; and
selecting one of the instantiations for each program module that has multiple instantiations based on at least one performance criterion associated with the application that depends on whether the program modules are active in respective states.

2. The method of claim 1, further comprising forming an objective function based on a combination of measures of performance characteristics associated with the application.

3. The method of claim 2, further comprising minimizing or maximizing the objective function based on the selection of one of the instantiations for each program module that has multiple instantiations.

4. The method of claim 3, wherein minimizing or maximizing the objective function comprises minimizing or maximizing the objective function subject to one or more constraints.

5. The method of claim 4, wherein at least one of the constraints comprises a budget that constrains a value of one of the measures.

6. The method of claim 2, wherein the objective function comprises a linear combination of the measures.

7. The method of claim 6, wherein the linear combination comprises a weighted sum in which a value of each measure is multiplied by a weight coefficient between zero and 1.

8. The method of claim 1, wherein the performance criterion comprises a measure of a performance characteristic associated with the application that includes a sum over the set of states.

9. The method of claim 1, wherein the performance criterion comprises a measure of a performance characteristic associated with the application that includes an extremum over the set of states.

10. The method of claim 1, wherein the performance criterion comprises a measure of a performance characteristic associated with the application that includes a sum over multiple program modules.

11. The method of claim 1, wherein the performance criterion comprises a measure of a performance characteristic associated with the application calculated based on a matrix that indicates which modules are active in a given state.

12. The method of claim 11, wherein a first dimension of the matrix corresponds to the number of modules and a second dimension of the matrix corresponds to the number of states, and elements of the matrix are nonzero if a module indicated by the first dimension is active in a state indicated by the second dimension and are zero otherwise.

13. The method of claim 12, wherein the second dimension is ordered so that consecutive elements correspond to consecutive states.

14. The method of claim 13, wherein selecting one of the instantiations for each program module that has multiple instantiations comprises:
identifying multiple groups of at least two program modules that are active in a single state or in a group of multiple consecutive states, each group corresponding to a submatrix of the matrix; and
selecting instantiations iteratively based at least in part on the submatrices.

15. The method of claim 1, wherein the performance characteristics associated with the instantiations include a program size of an instantiation of a program module.

16. The method of claim 15, wherein the performance the performance criterion comprises a measure of a program size of the application for a given selection of an instantiation for each program module that has multiple instantiations.

17. The method of claim 16, wherein the measure of the program size of the application for a given selection of instantiations comprises a sum of program sizes of selected instantiations.

18. The method of claim 1, wherein the performance characteristics associated with the instantiations include an amount of memory used by an instantiation of a program module during execution.

19. The method of claim 18, wherein the performance the performance criterion comprises a measure of an amount of memory used by the application for a given selection of an instantiation for each program module that has multiple instantiations.

20. The method of claim 19, wherein the measure of the amount of memory used by the application for a given selection of instantiations comprises a sum of amounts of memory used by selected instantiations of active program modules in a given state.

21. The method of claim 20, wherein the measure of the amount of memory used by the application for a given selection of instantiations comprises a maximum of the sum over the states.

22. The method of claim 1, wherein the performance characteristics associated with the instantiations include a time delay associated with a type of response from an instantiation of a program module in response to a user input.

23. The method of claim 22, wherein the application is configured to execute on a client that communicates with a server in response to the user input.

24. The method of claim 23, wherein a response from the instantiation of the program module is based at least in part on information received from the server.

25. The method of claim 23, wherein the time delay depends on a bandwidth associated with a connection between the client and the server.

26. The method of claim 22, wherein the time delay depends on an amount of memory used by the instantiation of the program module.

27. The method of claim 22, wherein the time delay depends on a state with which the application is associated during execution of the instantiation of the program module.

28. The method of claim 22, wherein each instantiation of a program module is associated with no more than one type of response to user input.

29. The method of claim 22, wherein at least one instantiation of a program module is associated with multiple types of response to user input, each type associated with a corresponding time delay.

30. The method of claim 22, further comprising categorizing different types of responses to user input and associated response times into groups.

31. The method of claim 30, wherein the different types of responses are categorized into groups according to associated computational requirements, memory requirements, and data access requirements.

32. The method of claim 1, wherein the application comprises a multi-threaded application in which at least some program modules include multiple threads.

33. The method of claim 1, wherein the set of multiple states includes states from which the application is able to interact with a user.

34. The method of claim 33, wherein at least some of the states are associated with one or more options presented to the user.

35. The method of claim 33, wherein at least some of the states are associated with a budget that constrains a measure of a performance characteristic associated with the application.

36. The method of claim 35, wherein at least one measure constrained by a budget associated with a state comprises a sum over program modules that execute in the associated state.

37. The method of claim 1, wherein the application corresponds to a plurality of program modules related according to a hierarchical structure that is arranged so that fewer than all of the program modules are active in a given state.

38. The method of claim 37, wherein the hierarchical structure is arranged so that no more than one program module at a given level of the hierarchy is active in a given state.

39. Software stored on a computer-readable medium, for configuring an application, the software including instructions for causing a computer system to:
receive information that specifies a set of multiple states with which the application is associated during execution;
receive information that specifies whether each of one or more program modules is active during respective states, at least some of the program modules having multiple instantiations configured to execute with different performance characteristics;
receive information that specifies performance characteristics associated with the multiple instantiations for each of at least some program modules that have multiple instantiations; and
select one of the instantiations for each program module that has multiple instantiations based on at least one performance criterion associated with the application that depends on whether the program modules are active in respective states.

40. A system for configuring an application, the system comprising:
an estimation module configured to
receive information that specifies a set of multiple states with which the application is associated during execution,
receive information that specifies whether each of one or more program modules is active during respective states, at least some of the program modules having multiple instantiations configured to execute with different performance characteristics, and
receive information that specifies performance characteristics associated with the multiple instantiations for each of at least some program modules that have multiple instantiations; and
a configuration module configured to select one of the instantiations for each program module that has multiple instantiations based on at least one performance criterion associated with the application that depends on whether the program modules are active in respective states.
